(19) United States
(12) Patent Application Publication
(10) Pub. No.: US 2003/0128093 A1
(43) Pub. Date: Jul. 10, 2003

(54) Coil structure for use with transformer of network product

(75) Inventor: Tang Yung-Chiang, Taoyuan (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Delta Electronics Inc.

(21) Appl. No.: 10/068,639

(22) Filed: Feb. 5, 2002

(30) Foreign Application Priority Data
Jan. 10, 2002 (TW) 091100264

(51) Int. Cl. H01F 17/04

(52) U.S. Cl. 336/221

(57) ABSTRACT

A transformer assembly structure with low voltage drift is provided. The transformer assembly structure includes a bobbin, a primary winding, a secondary winding and a core assembly. The primary winding and the second winding are wrapped around the bobbin. It is characterized in that the secondary winding is made of a ribbon-shaped coil with a rectangular cross-section.

### FIELD OF THE INVENTION

The present invention relates to a transformer assembly structure for use with a network product, and more particularly to a low voltage-drift transformer assembly structure. The present invention also relates to a coil structure as secondary windings of the transformer assembly.

### BACKGROUND OF THE INVENTION

A typical transformer assembly is fabricated by wrapping primary windings and secondary windings around a bobbin, and then covering these windings with a magnetic core. In the prior art, each of the primary winding and the secondary winding is made of copper and strip-shaped coil with a circular cross-section, as shown in FIG. 1(a). Although such coil is cost-effective, it has some inherent advantages. Referring to FIG. 1(b), even when such coil is idealistically wrapped around a bobbin (not shown), the minimum space g among adjacent wrapped coils is unable to be eliminated due to its inherent circular cross-section. In practice, the coil can not be wrapped as that in FIG. 1(b), and thus the space g is much higher than that wrapped idealistically.

It is found that leakage inductance of the transformer assembly is dependent on the extent of the space g. The leakage inductance adversely affects efficiency of the transformer assembly. In addition, the output load of the transformer assembly varies with the voltage drift thereof, which impairs quality of output signals. For example, the voltage drift is generally greater than several hundred millivolts, which is not suitable for transformers used for network products such as modems. Since network products demands low voltage drifts, e.g. lower than 45 mV, special winding processes are required for reducing its voltage drift when such transformer assemblies are applied to network products. Therefore, such transformer assembly is costly and timeconsuming.

### SUMMARY OF THE INVENTION

It is an object of the present invention to provide an improved transformer assembly structure for use with a network product so as to overcome the above-mentioned problems, in which the secondary winding thereof is made of a ribbon-shaped coil with a rectangular cross-section, so as to reduce space among the wrapped windings.

In accordance with an aspect of the present invention, there is provided a transformer assembly structure which includes a bobbin, a primary winding, a secondary winding and a core assembly. The primary winding and the second winding are wrapped around the bobbin. It is characterized in that the secondary winding is made of a ribbon-shaped coil with a rectangular cross-section.

Preferably, the coil is made of copper.

Preferably, the cross-section has a longer boundary and a shorter boundary in a range of from 1.5:1 to 30:1, and preferably from 5:1 to 20:1.

Certainly, the core assembly can include an EE core or an El core.

In accordance with another aspect of the present invention, there is provided a coil for use with a transformer of a network product, characterized in that the coil is made of a ribbon-shaped coil with a rectangular cross-section.

In accordance with another aspect of the present invention, there is provided a coil for use with a secondary winding of a transformer, characterized in that the coil is made of a ribbon-shaped coil with a rectangular cross-section.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a view showing a conventional coil for use with a transformer;

FIG. 1(b) schematically shows that the coil in FIG. 1(a) is idealistically wrapped around a bobbin;

FIG. 2(a) is a view showing a coil for use with a transformer according to a preferred embodiment of the present invention; and

FIG. 2(b) schematically shows that the coil in FIG. 2(a) is idealistically wrapped around a bobbin.

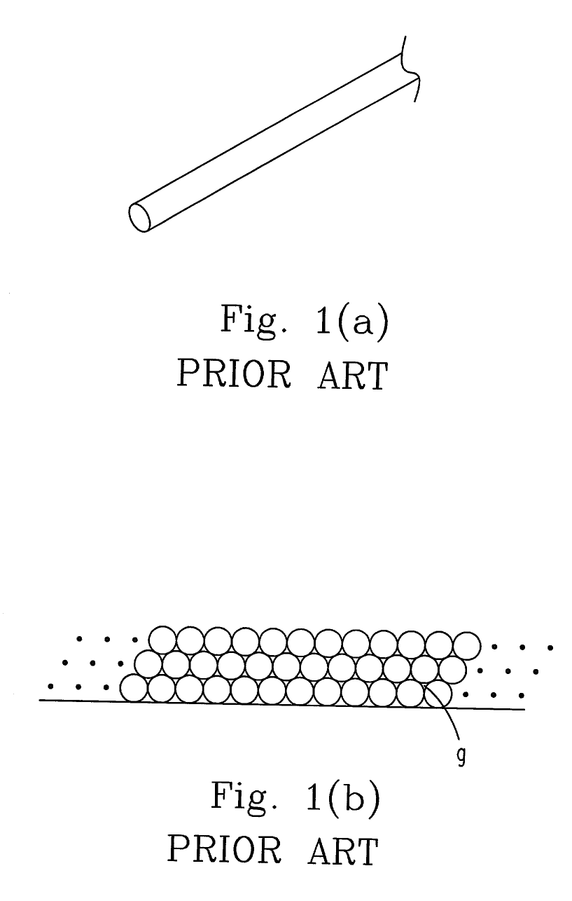

### DETAILED DESCRIPTION OF THE PREFERRED EMBODIMENT

The transformer assembly structure of the present invention includes a bobbin, a primary winding, a secondary winding and a core assembly, wherein the primary winding and the second winding are wrapped around the bobbin, and subsequently covered with the core assembly. Such structure is well known in the art and need not be further described in detail herein. In accordance with the present invention, the core assembly can include EE core or EI core.

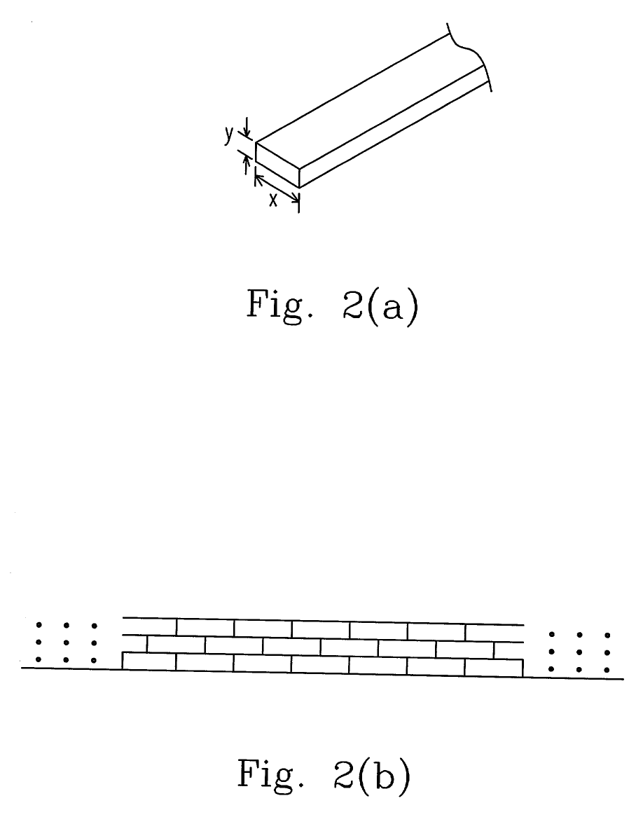

The transformer assembly structure of the present invention is distinguished by the coil structure of the secondary winding. In an embodiment, the secondary winding is made of a ribbon-shaped coil with a rectangular cross-section, as can be seen in FIG. 2(a). Preferably, the cross-section has a longer boundary x and a shorter boundary y in a range of from 1.5:1 to 30:1. More preferably, the longer boundary x and the shorter boundary y are in a range of from 1.5:1 to 30:1.

FIG. 2(b) schematically shows that the coil in FIG. 2(a) is idealistically wrapped around a bobbin (not shown). If the coil is idealistically wrapped, the space among adjacent wrapped coil could be entirely eliminated or minimized. Therefore, based on the winding process which provides close arrangement of the wrapped coil in the same layer, the coil of the present invention can overcome the inherent problem of larger leakage inductance for the conventional strip-shaped coil with a circular cross-section. Thus, the voltage drift of the transformer assembly could be minimized in practice.

By means of experiments, the transformer assembly having the present coil structure as secondary windings has low voltage drifts. In an test in which the input voltage is 110 or 220 V and the output voltage is 3.4 V with a current in a range of from 2.4 to 1.4 A, such transformer assembly has a voltage drift ranged from 7 to 11 millivolts. In another test in which the input voltage is 110 or 220 V and the output voltage is 6.0 V with a current in a range of from 625 to 250 mA, the transformer assembly has a voltage drift ranged from 20 to 30 millivolts. The transformer assembly in accordance of the present invention is suitable for network products, because its voltage drift is less than that of the conventional transformer and meets the requirement for network products.

It is of course that the coil of the present invention can also suitable as primary windings of transformer assembly.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer assembly structure comprising a bobbin, a primary winding, a secondary winding and a core assembly, said primary winding and said second winding being wrapped around said bobbin, characterized in that:
said secondary winding is made of a ribbon-shaped coil with a rectangular cross-section.

2. The transformer assembly structure according to claim 1 wherein said coil is made of copper.

3. The transformer assembly structure according to claim 1 wherein said cross-section has a longer boundary and a shorter boundary in a range of from 1.5:1 to 30:1.

4. The transformer assembly structure according to claim 1 wherein said cross-section has a longer boundary and a shorter boundary in a range of from 5:1 to 20:1.

5. The transformer assembly structure according to claim 1 wherein said core assembly includes a first E-shaped core and a second E-shaped core.

6. The transformer assembly structure according to claim 1 wherein said core assembly includes an E-shaped core and an I-shaped core.

7. A coil for use with a transformer of a network product, characterized in that said coil is made of a ribbon-shaped coil with a rectangular cross-section.

8. The coil according to claim 7 being made of copper.

9. The coil according to claim 7 wherein said cross-section has a longer boundary and a shorter boundary in a range of from 1.5:1 to 30:1.

10. The coil according to claim 7 wherein said cross-section has a longer boundary and a shorter boundary in a range of from 5:1 to 20:1.

11. A coil for use with a secondary winding of a transformer, characterized in that said coil is made of a ribbon-shaped coil with a rectangular cross-section.

12. The coil according to claim 11 being made of copper.

13. The coil according to claim 11 wherein said cross-section has a longer boundary and a shorter boundary in a range of from 1.5:1 to 30:1.

14. The coil according to claim 11 wherein said cross-section has a longer boundary and a shorter boundary in a range of from 5:1 to 20:1.
